(19) United States
(12) Patent Application Publication
(10) Pub. No.: US 2008/0228350 A1
(43) Pub. Date: Sep. 18, 2008

(54) Communication System For a Technical Device, in Particular For a Motor Vehicle

(75) Inventor: Tudor-Ion Gamulescu, Regensburg (DE)

Correspondence Address: LERNER GREENBERG STEMER LLP, P O BOX 2480, HOLLYWOOD, FL, 33022-2480, US

(73) Assignee: VDO AUTOMOTIVE AG, Regensburg (DE)

(21) Appl. No.: 12/088,166

(22) PCT Filed: Sep. 20, 2006
(86) PCT No.: PCT/EP2006/066556

§ 371 Date: May 22, 2008

(30) Foreign Application Priority Data
Sep. 28, 2005 (DE) 10 2005 046 373.8

(51) Int. Cl. G05B 9/03

(52) U.S. Cl. 701/35; 701/29

(57) ABSTRACT

A communication system for a technical device, in particular for a motor vehicle, contains a plurality of functional systems that are used to monitor and control various functions of the technical device. The functional systems each contain an evaluation unit and at least one functional component that is coupled to the evaluation unit in order to exchange signals. At least one of the functional systems is embodied such that it can detect a functional disturbance and/or a functional failure of at least one of the other functional systems, and in the event of a functional disturbance and/or a functional failure of the at least one other functional system it takes on at least part of the functionality of the at least one other functional systems.

The invention relates to a communication system for a technical device, in particular for a motor vehicle as well as to a motor vehicle with a communication system.

Many technical devices feature a large number of functional systems, which in each case are used to monitor and control various functions of the technical device. In such cases, a functional system in its most general form features an evaluation unit as well as at least one functional component which is coupled to the evaluation unit in order to exchange signals. In a motor vehicle such a functional system can for example be formed by a passenger protection system. In addition to a sensor system which is connected to the evaluation unit, this features an evaluation system for one or more protection systems. Another functional system usually existing in a motor vehicle for example involves communication devices and/or entertainment devices, which likewise have an evaluation unit and which are for example connected to a receiver unit and a functional unit which controls the communication function and/or the entertainment function. At the same time there are additional functional systems which for example relate to the actuation of an electric window lifter, electric seat adjustment, air conditioning or the ESP (Electronic Stability Program), etc.

In some functional systems, the sensor system can overlap with that of other functional systems, i.e. the one functional system uses sensor values, which have been made available from other functional systems, for example, on a bus.

These individual functional systems are operated independently and have no points of contact to each other. On the one hand, this offers the advantage of other functional systems not suffering as well in the event of a functional failure of the functional component or the evaluation unit of a functional system. On the other hand, the performance of the functional system which is affected by the functional failure of a functional component can be at least greatly restricted or can even fail altogether.

In order to prevent a complete failure of a functional system, the functional components existing within a functional system are frequently provided as redundant units. Linking them appropriately with one another means that both redundant functional components need to fail before the operability of the functional system is restricted. In such cases as a rule only the components of safety-relevant functional systems are embodied in a redundant manner for reasons of cost.

The object underlying the present invention is thus to provide a communication system for a technical device, in particular for a motor vehicle, which ensures improved safety in a simple manner in the event of failures of individual functional components.

This object is achieved in accordance with the invention by means of a communication system with the features of claim 1. Preferred embodiments of the invention emerge from the dependent claims.

The inventive communication system for a technical device, in particular for a motor vehicle, features a number of functional systems which are used to monitor and control various functions of the technical device and which comprises, respectively, an evaluation unit as well as at least one functional component which is coupled to the evaluation unit for the exchange of signals. At least one of the functional systems is embodied such that it can detect a functional disturbance and/or a functional failure of at least one of the other functional systems, and in the event of a functional disturbance and/or a functional failure of the at least one other functional system it takes over at least part of the functionality of the at least one other functional system.

Within the framework of the underlying invention, the term communication system is to be understood as a functional system network, which comprises a plurality of functional systems with different functions of both a communicative and a non-communicative nature.

The invention thus proposes a communication system, in the case of which the functional systems assigned to different technical functions are networked with each other such that the failure of a functional component of a functional system can be compensated for by another functional system. In this case the functional system taking over the functionality does not have to overlap in any way in accordance with the idea of the invention in its actual function with the function of the failing functional system. Needless to say, this also includes the case that the functionality is taken over by a functionally-similar functional system.

This means that the inventive communication system breaks down the hitherto strict separation between such functional systems as are used to monitor and control various functions of the technical device, which creates a fault-tolerant architecture of the communication system. This architecture allows networking and harmonization of the individual functional systems, such that at least safety-critical functionalities can be taken over by at least one of the further, remaining operative functional systems.

Above and beyond this, this procedure allows a special kind of error diagnosis, since this can now not only be carried out within one functional system, but cuts across a plurality of functional system boundaries. This makes possible a further optimization of assigned resources, since redundancies which considerably increase costs are now no longer necessary within a functional system. The one requirement necessary for this procedure is the linkage of the individual functional systems of a communication system, such that these functionalities can take over a functionality of a functional disturbance and/or a functional failure of a functional system.

In an embodiment of the invention, the functional system or the functional systems as functional components in each case feature at least one sensor unit which can supply a sensor output signal to the evaluation unit, and at least one control unit, which receives a control signal which is generated by the evaluation unit. In accordance with this embodiment, the functional system or the functional systems exhibit a classical subdivision of the functions into sensor detection, assessment/computation/evaluation and control of for example an actuator system. Such a division of a functional system is to be found in particular when used in motor vehicles.

In accordance with a further embodiment of the invention provision has been made for there to be a communication connection between the respective evaluation units of at least two of the functional systems. As a result of this, taking over of the functionality or a part of the functionality of an evaluation unit affected by a functional disturbance and/or a functional failure becomes possible.

In a further embodiment, the invention makes provision for a communication connection between the evaluation unit of one of the functional systems and the functional components of at least one of the other functional systems and vice versa to be provided. As a result of this, the sensor signals of a sensor system of a failing functional system can for example be detected by the evaluation unit of an operative functional system. If this evaluation unit is connected to the actuator system of the failing functional system, then its correct control in response to the signal detected by the sensor system is possible. For this reason, this inventive variant makes it possible to compensate for the failure of an evaluation unit of a functional system.

In accordance with one embodiment, the communication connection can be formed by the respective discrete lines or in another arrangement by a data bus. The latter possibility allows a particularly simple implementation of the cross-functional system architecture by means of appropriate modification to the messages transferred over the data bus.

In accordance with a further embodiment, in the event of a functional disturbance and/or a functional failure of the other functional system, the functional system taking over can determine which parts of the functionality of the other functional system are maintained and which parts of the functionality of the other functional system are not taken over. This procedure has the advantage that the resources, for example the memory or the processor power of a functional system taking over does not have to be dimensioned in such a way that a plurality of functionalities of different functional systems can be taken over and implemented at the same time. By selective resumption, in particular of safety-relevant functionalities, if need be, provision does not have to be made at all for the overdimensioning or changing (with the exception of the above-described, additional communication connection) of an existing, taking over functional system. As a result of this, the inventive communication system can also be implemented in an advantageous manner in terms of cost.

To allow the functionality of a failing functional system to be taken over by the other functional system, provision has been made for a central storage means in accordance with a further embodiment, which can be accessed by all the functional systems, and of which the data can be read out for the functional systems (in particular their evaluation units) of the communication system, it being possible that the data in the storage means comprises the configuration data and/or the code execution of the functional systems. This implementation makes it possible not to have to make provision for the fact that the configuration data and/or the execution codes necessary for the execution of certain functionalities are made available frequently in the communication system. By means of the central storage of this data and the possibility of the functional systems concerned of being able to access this data, one-off storage is sufficient, whereby the topology of the communication systems can be kept simple and for this reason the costs relatively low.

A further improvement arises as a result of the fact that the storage means comprises only configuration data and/or execution codes of those functional systems for which functionality can be taken over in the event of a functional disturbance and/or a functional failure by one of the functional systems. This can for example be data such as that relating to the safety-relevant functionalities such as for example passenger protection means in a motor vehicle. In accordance with this development, data which for example relates to the comfort characteristics of a motor vehicle and is not necessarily of importance for the safe operation of the motor vehicle, does not have to be made available in the memory, whereby said memory can therefore have small dimensions.

In accordance with an embodiment, provision has been made for a CD (Compact Disc) or a DVD (Digital Versatile Disc) as the storage means. As a result of this, the data necessary for the taking over of the functionality can be made available in a particularly simple and cost-effective manner. An especially efficient solution is achieved in particular, if in the case of this storage means, it is a navigation CD or a navigation DVD, which in addition to the navigation data for a navigation system of a motor vehicle comprises the configuration data and/or the execution code of some or all of the functional systems. Over and above that, the use of such a storage means creates the possibility of being able to make updated configuration data and/or execution codes available in a simple manner.

In accordance with another variant, at least one of the functional systems has a storage means, of which the data can be read out by means of the functional system concerned, whereby the data in the storage means comprises configuration data and/or execution codes of the functional system or the functional systems of which the functionality is to be taken over by another functional system in the event of a functional disturbance and/or a functional failure. In accordance with this variant, provision has to be made for the fact that appropriate data necessary for the taking over of the functionality is made available in the specific functional system, which is selected for taking over the functionality.

Provision has been made for the communication system in accordance with the invention to be used in a motor vehicle. The subject matter of the invention is likewise a motor vehicle, which has a communication system of the kind described above.

The idea of the invention can thus be seen as providing a redundancy, which is implemented to cut across functional system boundaries. The functional systems providing the redundancy in each case primarily carry out different functions from each other here so that the redundancy is not created by the duplicated provision of identical functional components.

The invention and its advantages are described in more detail below with reference to the exemplary embodiments specified in the figures. They are as follows:

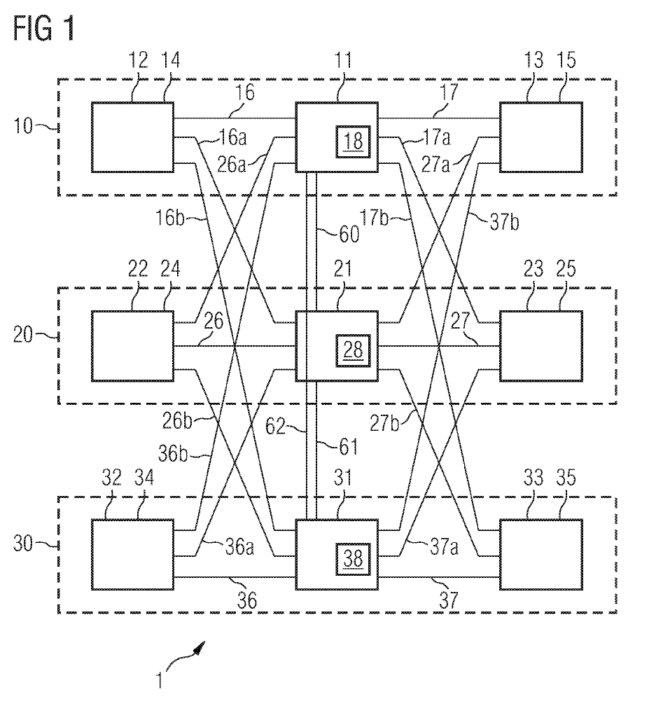

FIG. 1 a first exemplary embodiment of a communication system in accordance with the invention, and

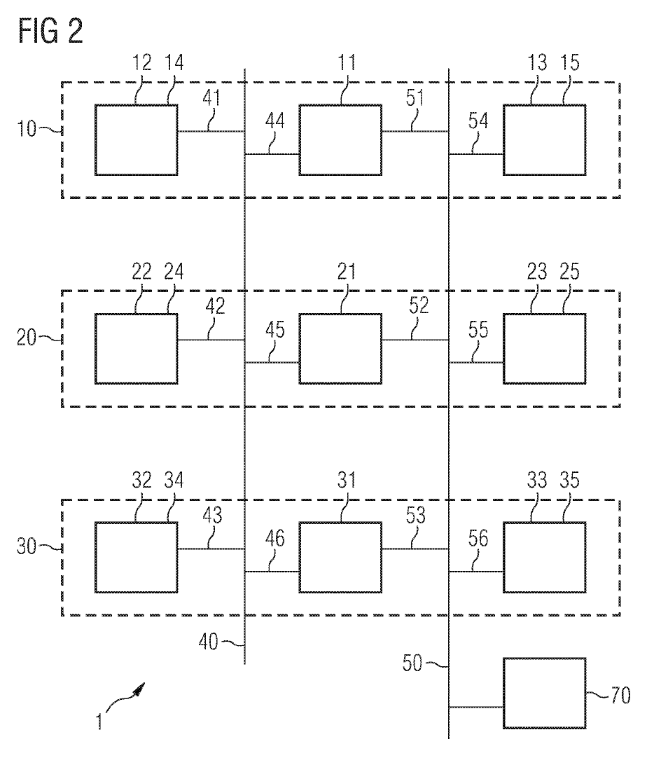

FIG. 2 a second exemplary embodiment of a communication system in accordance with the invention.

FIG. 1 shows a first exemplary embodiment of a communication system 1 in accordance with the invention. The communication system 1 has three exemplary functional systems 10, 20, 30. The functional systems 10, 20, 30 are used to monitor and control various functions of the communication system 1. The communication system 1 can for example be configured in a motor vehicle.

Each one of the functional systems 10, 20, 30 has an evaluation unit 11, 21, 31 as well as the functional components 12, 13 or 22, 23 or 32, 33 connected to these. The functional components 12, 22, 32 can for example be configured as the sensor units 14, 24, 34. The functional components 13, 23, 33 can for example configure the control units 15, 25, 35. The functional components of a functional system are in each case connected by means of lines 16, 17 or 26, 27 or 36, 37 to the evaluation unit 11 or 21 or 31 of the specific functional system 10, 20, 30.

In order that the functional system 10 can for example take over the functionality or at least parts thereof of the other functional systems 20, 30, the functional unit 12 is connected by means of lines 16a, 16b to the evaluation units 21 or 31 of the functional system 20, 30. The functional component 13 is connected by means of lines 27a, 37b to the evaluation units 21 or 31 of the functional system 20, 30 in an appropriate manner. In order that a functional taking over of the functionalities of the functional systems 10, 30 is possible by the functional system 20, the functional units 22 and 23 of the functional system 20 are for this reason connected by means of the respective lines 26a, 26b or 17a, 37a to the evaluation units 11 or 31 of the functional systems 10 and 30. Provision has been made for a direct connection by means of lines 36b, 36a as well as 17b, 27b of the functional components 32, 33 of the functional system 30 to the evaluation units 11, 21 of the functional systems 10, 20 in an appropriate manner.

In addition, there is a specific connection between the evaluation units 11, 21, 31 of the functional systems 10, 20, 30. To this end, these are connected by means of the respective lines 60, 61, 62 to each other.

Over and above that, each one of the evaluation units 11, 21, 31 is provided with a storage means 18 or 28 or 38. The storage means 18 of the evaluation unit 11 contains the configuration data and/or the execution code of the functional systems 20, 30. The configuration data and/or the execution code of the functional systems 10, 30 is stored in the storage means 28. The storage means 38 comprises the configuration data and/or the execution code of the functional systems 10, 20. At the same time, the configuration data and/or the execution code of the functional system 10, 20, 30 concerned is itself also contained in the respective storage means 18, 28, 38 (or in additional storage means not shown in the figure).

The described communication topology of the individual components of the functional systems makes it possible to detect and compensate for the functional failures of the individual components.

If the functional component 22 of the functional system 20 fails for example, then the functional system 20 is no longer able to make available the functionality associated with it. If the functional component 22 concerns a delay sensor for example, then the information expected from the evaluation unit 21 can for example also be made available by means of the functional component 12 of the functional system 10, if it likewise concerns an acceleration sensor in this case. Even if, within the framework of the functional system 10, it is used to fulfill another functionality, the evaluation unit 21 can use the data supplied by the functional component 12 for further processing in order to be able to control the functional component 23 of the functional system 20 in a corresponding manner.

If the evaluation unit 31 of the functional system 30 fails for example, then the functionality of the functional system 30—despite functioning functional components 32, 33—can no longer be maintained. The assessment and evaluation of the data supplied by the functional component 32 can in accordance with the idea of the invention, instead be processed by the evaluation unit 11 and/or the evaluation unit 21 of the functional systems 10, 20. For this purpose, they detect the failure of the evaluation unit 31, while monitoring for example the absence of messages on the lines 61, 62 to the evaluation unit 31. Owing to the facility for accessing the configuration data and/or the execution code of the evaluation unit 31 in their memories 18, 28, the data supplied by the functional component 32 can be evaluated. If necessary, a check of the functional component 33 is carried out by one of the evaluation units 11 or 21.

The failure of one of the functional components 13, 23, 33 can be dealt with in an appropriate manner.

In order to take over the functionality of a functional component or an evaluation unit of a functional system it is necessary for the diagnosis of a failure of these units to be able to be detected by at least the other functional systems. This can be done for example via suitable communication procedures between the respective functional units.

The architecture of the communication system 1 in accordance with the invention makes it possible for the respective functional systems 10, 20, 30 to be made available without respective redundancies within one of the functional systems. The redundancy is actually instead made available by cutting across communication boundaries between the functional systems independently of each other.

Contrary to the graphic representation depicted in FIG. 1, it is not absolutely necessary for a communication connection is present between all the functional systems 10, 20, 30. The architecture of the communication system can also be designed to the effect that only some of the functional systems have a communication connection to each other, but not to other functional systems. The selection of which functional systems should be linked among each other can be carried out according to principal points of the functionality made available in each case, in particular the monitoring and control functions of the functional systems. Provision has to be made in particular for a networking of such functional systems, which fulfill the safety-critical functions within a technical device.

FIG. 2 shows a second exemplary embodiment of the communication system 1 in accordance with the invention. This features, as in the preceding example, only three exemplary functional systems 10, 20, 30. Each one of the functional systems 10, 20, 30 has—as in the preceding exemplary embodiment—again only exemplary—two functional components 12, 13 or 22, 23 or 32, 33, which are located in communication connection to a specific evaluation unit 11, 21, 31.

The communication connection within the components of a functional system, however also to the components of another functional system is made in accordance with this exemplary embodiment by means of the bus lines 40, 50. The functional components 12, 22, 32 are connected to said bus lines by means of the respective lines 41, 42, 43. The evaluation units 11, 21, 31 are connected to the two bus lines 40, 50 by means of lines 44, 51 or 45, 52 or 46, 53 in an appropriate manner. The bus line 50 is connected to the respective functional components 13, 23, 33 via lines 54, 55, 56.

The communication structure represented in this exemplary embodiment makes possible in particular the communication of a plurality of functional systems 10, 20, 30 in a simple manner, without having to make major changes to the hardware components. The corresponding communication takes place by means of modification or adaptation to the messages transferred by means of the bus lines 40, 50 or by means of an adaptation to the protocols used for it. As a result, the data provided by a functional component of a certain functional system can thereby for example be used by one of the other functional systems within the framework of normal operation for processing. Measured values which have been made available by a certain sensor can definitely be processed by a plurality of functional systems.

Configuration data and/or execution codes necessary for the taking over of the functionality of a failing functional system have to be made available in the exemplary embodiment in accordance with FIG. 2 in a central storage means 70, which is located in communication connection to the bus line 50. The storage means 70 can be any memory type such as for example a hard disk or another non-volatile memory. In motor vehicles, in particular a CD or a DVD come into consideration as the storage means, which for example contains the navigation data for a navigation system of the motor vehicle. In this way, it is not necessary to make provision for additional hardware components in the communication system in order to make available the mutual monitoring and control of a plurality of functional components.

1-12. (canceled)

13: A communication system for a technical device, the communication system comprising:
a plurality of functional systems for monitoring and controlling various functions of the technical device, said functional systems each containing an evaluation unit and at least one functional component coupled to said evaluation unit for exchanging signals, at least one of said functional systems embodied to:
detect at least one of a functional disturbance and a functional failure of at least one of said other functional systems; and
in an event of one of the functional disturbance and the functional failure of at least one of said other functional systems, said at least one functional system takes over at least part of a functionality of said other functional system.

14: The communication system according to claim 13, wherein said at least one function component of at least one of the said functional systems contains at least one sensor unit for supplying a sensor output signal to said evaluation unit, and at least one control unit, for receiving a control signal generated by said evaluation unit.

15: The communication system according to claim 13, further comprising a communication connection between said evaluation units of at least two of said functional systems.

16: The communication system according to claim 14, further comprising a communication connection between said evaluation unit of one of said functional systems and a functional component of at least one of said other functional systems and vice versa.

17: The communication system according to claim 16, wherein said communication connection is one of discrete lines and a data bus.

18: The communication system according to claim 13, wherein in an event of one of the functional disturbance and the functional failure of one of said other functional systems, said one function system being a taking over function system determines which parts of the functionality of said other functional system are maintained and which parts of the functionality of said other functional system are not taken over.

19: The communication system according to claim 13, further comprising a central storage device being accessed by all said functional systems and whose data can be read out for said functional systems of the communication system, it being possible that said data in said storage device contains at least configuration data and execution codes of said functional systems.

20: The communication system according to claim 19, wherein said storage device contains only the configuration data and the execution codes of such said functional systems, whose functionality in an event of the functional disturbance and the functional failure can be taken over by another one of said functional systems.

21: The communication system according to claim 19, wherein said storage device is selected from the group consisting of compact discs and digital versatile discs.

22: The communication system according to claim 13, wherein at least one of said functional systems has a storage device whose data can be read out by a taking over functional system, whereby the data in said storage device contains at least one of configuration data and execution codes of said functional system whose functionality in the event of one of the functional disturbance and the functional failure is to be taken over by another one of said functional systems.

23: The communication system according to claim 1, wherein the technical device is a motor vehicle.

24: A method of using a communication system, which comprises the step of:
providing a motor vehicle with a communication system, the communication system containing a plurality of functional systems for monitoring and controlling various functions of the motor vehicle, the functional systems each containing an evaluation unit and at least one functional component coupled to the evaluation unit for exchanging signals, at least one of the functional systems is embodied to:
detect at least one of a functional disturbance and a functional failure of at least one of the other functional systems; and
in an event of one of the functional disturbance and the functional failure of the at least one other functional system, said at least one functional system takes over at least part of the functionality of the at least one other functional system.

25: A motor vehicle, comprising:
a communication system containing:
a plurality of functional systems for monitoring and controlling various functions of the motor vehicle, said functional systems each containing an evaluation unit and at least one functional component coupled to said evaluation unit for exchanging signals, at least one of said functional systems embodied to:
detect at least one of a functional disturbance and a functional failure of at least one of the other functional systems; and
in an event of one of the functional disturbance and the functional failure of the at least one other functional system, said at least one functional system takes over at least part of the functionality of the at least one other functional system.
